(19) United States
(12) Patent Application Publication
(10) Pub. No.: US 2018/0149529 A1
(43) Pub. Date: May 31, 2018

(54) ARRANGEMENT AND USE OF A WORKPIECE MADE OF STEEL FOR MEASURING A FORCE OR A TORQUE

(71) Applicant: Schaeffler Technologies AG & Co. KG, Herzogenaurach (DE)

(72) Inventors: Stephan Neuschaefer-Rube, Herzogenaurach (DE); Jan Matysik, Nurnberg (DE); Markus Neubauer, Memmelsdorf (DE); Christian Schmitt, Niederwerrn (DE); Thomas Dirnberger, Obermichelbach (DE)

(73) Assignee: Schaeffler Technologies AG & Co. KG, Herzogenaurach (DE)

(21) Appl. No.: 15/574,627

(22) PCT Filed: May 4, 2016
(86) PCT No.: PCT/DE2016/200212

§ 371 Date: Nov. 16, 2017

(30) Foreign Application Priority Data
May 21, 2015 (DE) 10 2015 209 319.0

(51) Int. Cl. G01L 1/12; G01L 3/10

(52) U.S. Cl. CPC G01L 1/125; G01L 3/102

(57) ABSTRACT

An arrangement for measuring a force and/or a torque using the inverse-magnetostrictive effect includes a workpiece made from steel as a primary sensor for a measurement of a force and/or a torque using the inverse-magnetostrictive effect. The arrangement includes a machine element on which the force or the torque acts, which causes mechanical stress and the machine element is usually slightly deformed. The machine element is formed of steel and has at least one magnetostrictive area for a magnetization, which forms a primary sensor for measuring the force and/or the torque. The arrangement further includes at least one magnetic field sensor for measuring a magnetic field caused by the magnetization and also by the force and/or by the torque. The magnetic field sensor forms a secondary sensor for measuring the force and/or the torque. The machine element is formed by a plastically shaped workpiece, wherein it undergoes a plastic shape forming process through which the machine element is formed for transmitting the force and/or the torque.

### BACKGROUND

The present invention relates first to an arrangement for measuring a force and/or a torque using the inverse-magnetostrictive effect. The invention further relates to a use of a workpiece made from steel as a primary sensor for measuring a force and/or a torque using the inverse-magnetostrictive effect.

DE 689 18 978 T2 shows a magnetostrictive torque converter with a shaft part made from a steel that can contain, in addition to carbon, silicon, manganese, aluminum, nickel, and chrome, also, among others, lead or copper.

EP 0 525 551 B1 discloses a circular magnetized torque sensor and a transfer ring suitable for this sensor. Different materials, e.g., alloys of iron and nickel or aluminum are specified for the transfer ring.

From EP 2 216 702 B1, a sleeve-less torque sensor with a rotating element made from a steel is known. The steel can be formed, for example, by high-carbon steel with 12% manganese and 1.2% carbon or by TRIP steel. It is further described to form multiple phases in the rotating element, for which individual areas can be plastically deformed.

In the scientific article by Mark S. Boley, Doug A. Franklin, and David K. Rigsbee: “Heat Treatment Effects on Sensitivity and Hysteresis Loops of Magnetoelastic Torque Transducers” in the Journal of Applied Physics, 87th volume, issue 9, 2000, pp. 7073-7075 and in the scientific article by Mark S. Boley, David K. Rigsbee, and Doug A. Franklin: “The Effects of Heat Treatments on the Magnetic Behavior of Ring-Type Magnetoelastic Torque Sensors” in Sensors for Industry, Proceedings of the First ISA/IEEE Conference 2001, pp. 203-206, properties of magnetostrictive primary sensors before and after a heat treatment are described. The heat treatment significantly increases the sensitivity of the primary sensor. The profile of the magnetic hysteresis curve is also affected, so that the stability of the surrounding magnetization is improved.

From the scientific article by Marilyn Wun-Fogle, James B. Restorff, James M. Cuseo, Ivan J. Garshelis, and Sami Bitar: “Magnetostriction and Magnetization of Common High Strength Steels” in IEEE Transactions on Magnetics, 45th volume, issue 10, 2009, pp. 4112-4115, it is known that a heat treatment process of a magnetostrictive primary sensor is desired that guarantees the most complete possible conversion of the austenite into martensite.

The scientific article by Mark S. Boley, Doug A. Franklin, and Jason T. Orris: “The Effects of Chromium Concentration on Magnetically Polarized Heat-Treated Steel Torque Transducer Shafts” in IEEE Transactions on Magnetics, 40th volume, issue 4, part 2, 2004, pp. 2661-2663 shows a study on the influence of chromium in a magnetostrictive primary sensor material on the sensor sensitivity. The sensitivity increases accordingly with increasing chromium content.

From a product information disclosure of Torque and More GmbH: “TAM Passive Sensors,” available at http://www.tam-sensors.com/passive-torque-sensing, 2013, it is known that a mechanical hardness of greater than 50 HRC of a magnetostrictive primary sensor has an advantageous effect on the hysteresis. The higher the hardness, the smaller the signal hysteresis of the detected magnetic field can be on the mechanically loaded primary sensor. For the material 45NiCrMo16, a hardness of 55 HRC is recommended. For the material 50NiCr13, a hardness of 59 HRC is recommended.

### SUMMARY

The objective of the present invention is in providing, starting from the prior art, a measurement of forces and/or torques using the inverse-magnetostrictive effect on machine elements that are to be produced with low expense and here act as sensitive primary sensors.

The specified objective is achieved by an arrangement having one or more features of the invention.

The arrangement according to the invention is used for measuring at least one force and/or a torque. The arrangement comprises a machine element on which the at least one force or the at least one torque acts, wherein these lead to mechanical stress and the machine element is usually slightly elastically deformed. The torque is formed preferably by a torsion moment.

The machine element consists of steel and has at least one magnetostrictive area for a magnetization, whereby it forms a primary sensor for measuring the force and/or the torque. The machine element preferably has a completely magnetostrictive design.

The arrangement according to the invention further comprises at least one magnetic field sensor for measuring a magnetic field or magnetic field change caused by the magnetization and also by the force and/or by the torque. The magnetic field sensor forms a secondary sensor for measuring the force and/or the torque. The primary sensor is used for converting the force to be measured or the torque to be measured into a corresponding magnetic field, while the secondary sensor allows the conversion of this magnetic field or a change in this magnetic field into an electrical signal. The magnetic field caused by the magnetization and also by the force and/or by the torque occurs due to the inverse-magnetostrictive effect. Thus, the measurement that is possible with the arrangement according to the invention uses the inverse-magnetostrictive effect.

According to the invention, the machine element is formed by a plastically shaped workpiece made from steel, wherein it undergoes a plastic shape forming process through which the machine element is constructed for transmitting the force and/or the torque. The machine element is thus a workpiece that was produced such that a semi-finished product was plastically shaped from steel, so that the workpiece obtains the shape through which it can fulfill its original function as a machine element; namely for transmitting the force and/or the torque. In contrast to the prior art, this shaping is realized, for example, not by a metal-cutting method. The outer shape of the machine element is determined at least partially by the plastic shape forming process. The outer shape of the machine element is preferably completely determined by the plastic shape forming process.

One particular advantage of the arrangement according to the invention is provided in that the machine element of the arrangement can be produced with low expense such that it receives its shape through a plastic shape forming process. Another advantage is provided in that the steel has improved magnetostrictive properties due to the plastic shape forming process.

In preferred embodiments of the arrangement according to the invention, the machine element is formed by a thermally plastically shaped workpiece. Consequently, the shaping of the workpiece is realized by a thermal plastic shape forming process, i.e., through a plastic shape forming process under the supply of heat that leads to an increased temperature during the plastic shape forming process.

In especially preferred embodiments of the arrangement according to the invention, the machine element is formed as a forged workpiece. Consequently, the shape forming of the workpiece is realized by forging, which involves thermal plastic forming. Forging allows low-expense shaping of the workpiece so that the machine element can fulfill its original function as a machine element, namely the transmission of the force and/or the torque.

The plastic shaping imparts several features to the machine element. The workpiece has a grain structure with flow lines that can be detected, for example, after cutting through the machine element and after micro-etching of the cut surface. The flow lines are produced and deflected by the plastic shaping, i.e., not straight; for example, due to the effect of forces during forging. The grain structure is not only oriented parallel to an axis of the machine element. In contrast, a non-plastically shaped workpiece would have a grain structure parallel to an axis of the workpiece.

For preferred embodiments of the arrangement according to the invention, the workpiece is formed by a plastically shaped continuous casting.

The following information relates to the steel that makes up the completely manufactured machine element.

The steel preferably has a carbon content between 0.2% and 0.6%. The steel has, in an especially preferred embodiment, a carbon content between 0.4% and 0.5%.

The steel has an austenite content of preferably at most 6%. More preferably, the steel has an austenite content of at most 3%.

The steel preferably contains chromium. The steel preferably also contains nickel and/or molybdenum.

The steel is preferably 50NiCr13 or 45NiCrMo16.

The steel has a surface hardness of preferably at least 500 HV 10. In the case of 50NiCr13, the surface hardness is preferably 600+120 HV 10. In the case of 45NiCrMo16, the surface hardness is preferably 580+100 HV 10.

The steel has a core hardness of preferably at least 500 HV 5. In the case of 50NiCr13, the core hardness is preferably 600+100 HV 5. In the case of 45NiCrMo16, the core hardness is preferably 580+100 HV 5.

The steel or the workpiece has a coercive field strength of preferably at least 1000 A/m. The steel or the workpiece has a coercive field strength of especially preferred at least 1500 A/m. This is preferably the coercive field strength in the tangential direction.

The magnetization is preferably formed by a permanent magnetization. Consequently, at least the magnetostrictive area is permanently magnetized.

In an alternatively preferred way, the magnetization is formed by a temporary magnetization. In this case, the arrangement according to the invention also comprises a magnet for the magnetization of the magnetostrictive area. The magnet can be formed, in particular, by a permanent magnet or by an electromagnet.

The permanent or temporary magnetization is preferably magnetically neutral in a state of the machine element unloaded by a force or by a torque toward the outside of the machine element, so that no technically relevant magnetic field can be measured outside of the machine element.

The magnetization is preferably annular in one or more tracks, wherein an axis of the machine element also forms a middle axis of the respective ring shape.

The magnetization extends preferably circumferentially about an axis of the machine element. Thus, it is a magnetization surrounding the axis, wherein the axis itself preferably does not form part of the magnetization. The magnetization preferably has a tangential orientation with respect to a surface of the machine element extending around the axis. The magnetization preferably has only a tangential orientation with respect to a surface of the machine element extending around the axis. The magnetization extends preferably along a closed path around the axis, wherein the magnetization may have short gaps. If the magnetization is formed in multiple tracks, these tracks preferably have an equal spatial extent and are spaced apart axially. The polarity of the magnetization into the multiple tracks is preferably alternating.

The machine element is preferably formed by a shaft or by a flange. The outer shape of the shaft or the flange is defined by the plastic shaping. The machine element, however, can also be formed by other machine element types.

In particular embodiments of the arrangement according to the invention, the machine element is hollow; for example, in the form of a hollow shaft or a hollow flange.

The one or more magnetic field sensors is preferably formed by a semiconductor sensor, e.g., by a Hall or xMR sensor, or by a coil, e.g., by a flux gate magnetometer. In principle, a different sensor type could also be used if it is suitable for measuring the magnetic field.

The machine element of the arrangement according to the invention is preferably also characterized by its production. This production comprises a step in which a semi-finished product is plastically shaped from a steel, in order to produce the machine element in the form of a plastically shaped workpiece. The semi-finished product is preferably a continuous casting. For the plastic deformation, the semi-finished product is preferably heated, especially preferred above the recrystallization temperature of the steel. The plastic shaping is preferably realized by forging. The forging is preferably performed in a direction in which rows and grains are oriented in a macro level of the steel. After the workpiece has been heated and plastically shaped, it is preferably hardened, for which it is subjected to a heat treatment. The heat treatment preferably comprises a step in which the workpiece is heated at least up to the austenitization temperature of the steel, for which heating and through heating of the workpiece is performed. Then the achieved temperature is preferably maintained beyond a hold period, in order to guarantee austenitization of the steel. Then the workpiece is cooled, for which it is preferably quenched in a medium. Here, deep cooling of the workpiece is preferably performed beyond a cooling hold period, in order to guarantee a complete microstructural transformation. The cooling of the workpiece is realized preferably below the martensite start temperature MS and especially preferred below the martensite finish temperature MF, which can be far below 0° C. Furthermore, the workpiece is preferably annealed for longer than an annealing hold period. The heat treatment is preferably performed such that the austenite content of the workpiece decreases to 6% or less. The heat treatment is performed in an especially preferred way such that the austenite content of the workpiece decreases to 3% or less, which usually falls below a lower detection limit.

In particularly preferred embodiments of the arrangement according to the invention, the machine element is formed by a thermally plastically shaped workpiece that has furthermore undergone the heat treatment described above for reducing the austenite content. The machine element still has increased sensitivity as a primary sensor for the measurement using the inverse-magnetostrictive effect due to these two thermal treatments. The machine element is preferably formed by a thermally plastically shaped workpiece, whose austenite content is at most 6%; especially preferred at most 3%.

In the use according to the invention, a plastically shaped workpiece made from a steel is used as a machine element for transmitting a force and/or a torque and also as a primary sensor for a measurement of the force and/or the torque using the inverse-magnetostrictive principle. The workpiece or the machine element preferably also has the features that are described in connection with the arrangement according to the invention. The workpiece or the machine element is preferably produced according to the production steps described in connection with the arrangement according to the invention.

### BRIEF DESCRIPTION OF THE DRAWINGS

Additional details, advantages, and refinements of the invention are given from the following description of a preferred embodiment of the invention, with reference to the drawing. Shown are:

FIG. 1 a first forging state of a workpiece for a machine element to be used according to the invention in a cross-sectional view;

FIG. 2 a second forging state of the workpiece shown in FIG. 1 in a cross-sectional view; and

FIG. 3 a third forging state of the workpiece shown in FIG. 1 in a cross-sectional view.

### DETAILED DESCRIPTION

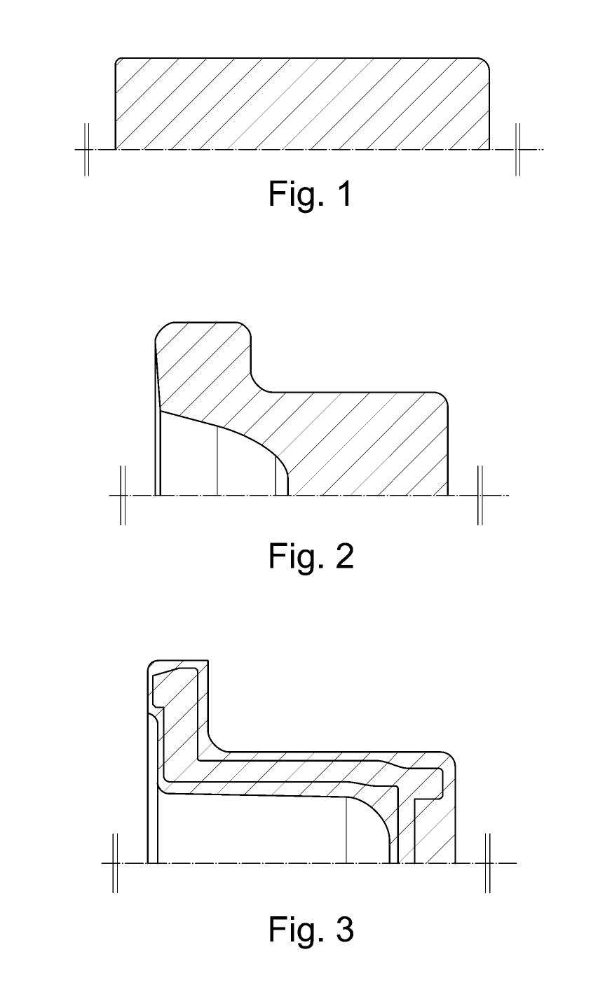

FIG. 1 shows, as an example, a workpiece for a machine element to be used according to the invention as a blank in a first forging state in a cross-sectional view. For this first forging state, as an example, a continuous casting was prepared as carbon steel that was sheared at a temperature between 1150° C. and 1180° C. The continuous casting has, for example, a pipe diameter of 45 mm and was sheared to a length of 98 mm.

FIG. 2 shows the workpiece shown in FIG. 1 in a second forging state in a cross-sectional view. Compared with the forging state shown in FIG. 1, the workpiece was plastically shaped by forging.

FIG. 3 shows the workpiece shown in FIG. 1 in a third forging state in a cross-sectional view. Compared with the forging state shown in FIG. 2, the workpiece was further plastically shaped by forging, so that it essentially obtained the shape that characterizes it as a machine element for transmitting a force and/or a torque. The still soft workpiece can be reworked. Then a heat treatment that comprises hardening, deep cooling, and annealing is performed. The manufactured machine element is used according to the invention, first, for transmitting force and/or torque and, second, as a primary sensor for a measurement of the force and/or torque using the inverse-magnetostrictive effect. The shown machine element is, for example, a hollow flange that is permanently magnetized all around for its function as a primary sensor.

1. An arrangement for measuring at least one of a force or a torque; comprising:
a machine element made from a steel that is constructed for loading by at least one of a force or a torque, the machine element having at least one magnetostrictive area for a magnetization, and forming a primary sensor for measuring the at least one of the force or the torque;
a magnetic field sensor that measures a magnetic field caused by the magnetization and by the at least one of the force or the torque, which forms a secondary sensor for measuring the at least one of the force or the torque;
the machine element is comprised of a plastically shaped workpiece formed by a plastic shaping process by which the machine element for transmitting the at least one of the force or the torque is constructed.

2. The arrangement according to claim 1, wherein the machine element is formed by a thermally plastically shaped workpiece.

3. The arrangement according to claim 1, wherein the machine element is formed by a forged workpiece.

4. The arrangement according to claim 1, wherein the workpiece has a grain structure with flow lines.

5. The arrangement according to claim 1, wherein the steel has a carbon component between 0.2% and 0.6%.

6. The arrangement according to claim 1, wherein the steel has an austenite content of at most 6%.

7. The arrangement according to claim 6, wherein the steel has an austenite content of at most 3%.

8. The arrangement according to claim 1, wherein the workpiece has a coercive field strength of at least 1500 A/m.

9. The arrangement according to claim 1, wherein the machine element is formed by a hollow shaft or by a hollow flange.

10. A sensor comprising: of a plastically shaped workpiece made from a steel as a machine element for transmitting at least one of a force or a torque and as a primary sensor for a measurement of the at least one of the force or the torque using the inverse-magnetostrictive effect, the machine element including at least one magnetostrictive area for a magnetization, and a magnetic field sensor as a secondary sensor.
